(19) United States
(12) Patent Application Publication
(10) Pub. No.: US 2026/0187727 A1
(43) Pub. Date: Jul. 2, 2026

(54) DETERMINING RISK SCORES FOR A USER BASED ON BEHAVIORAL INFERENCES FROM USER IOT DATA

(71) Applicant: Quanata, LLC, San Francisco, CA (US)

(72) Inventor: John William Kramer, Mechanicsburg, PA (US)

(73) Assignee: Quanata, LLC, San Francisco, CA (US)

(21) Appl. No.: 19/007,156

(22) Filed: Dec. 31, 2024

(51) Int. Cl. G06Q 40/08

(52) U.S. Cl. CPC G06Q 40/08

(57) ABSTRACT

A computer-implemented method including receiving a first set of sensor data associated with a user from one or more first IoT devices of the user related to a first domain. The method also can include receiving a second set of sensor data associated with the user from one or more second IoT devices of the user related to a second domain. The method additionally can include analyzing the first set of sensor data associated with the user from the one or more first IoT devices of the user related to the first domain and the second set of sensor data associated with the user from the one or more second IoT devices of the user related to the second domain to identify one or more risks of the user. The method further can include generating one or more risk scores associated with the user based on the one or more risks of the user. The method additionally can include recalculating an insurance premium for one or more of a multi-domain insurance policy of the user, a first-domain insurance policy of the user, a second-domain insurance policy of the user, or a third-domain insurance policy of the user based on the one or more risk scores associated with the user.

### FIELD OF THE DISCLOSURE

The present disclosure generally relates to determining risk scores for a user, and more particularly, determining risk scores for a user based on behavioral inferences from user Internet of Things (IoT) data.

### BACKGROUND

IoT represents a collective network comprised of various IoT systems, IoT devices, and/or IoT sensors that can collect and exchange IoT data associated with individuals (e.g., users) over a network (e.g., Internet) with various other IoT systems, IoT devices, and/or IoT sensors. These IoT systems, IoT devices, IoT sensors, and/or IoT data can be related to one or more domains (e.g., vehicles, dwellings, healthcare, etc.).

### BRIEF DESCRIPTION OF THE DRAWINGS

The figures described below depict various aspects of the systems and methods disclosed herein. It shall be understood that each figure can depict an embodiment of a particular aspect of the disclosed systems and methods, and that each of the figures is intended to accord with a possible embodiment thereof. Further, wherever possible, the following description refers to the reference numerals included in the following figures, in which features depicted in multiple figures can be designated with consistent reference numerals.

There are, shown in the drawings, arrangements which are presently discussed, it being understood, however, that the present embodiments are not limited to the precise arrangements and are instrumentalities shown, wherein:

FIG. 1 illustrates a front elevation view of a computer system that is suitable for implementing an example embodiment of the system disclosed in FIG. 3;

FIG. 2 illustrates a representative block diagram of an example embodiment of the elements included in the circuit boards inside a chassis of the computer system of FIG. 1;

FIG. 3 illustrates a system for determining risk scores for a user based on behavioral inferences from user IoT data, according to an example embodiment; and

FIG. 4 illustrates a flowchart for a method for determining risk scores for a user based on behavioral inferences from user IoT data, according to an example embodiment.

The figures depict various embodiments for the purposes of illustration only. One skilled in the art can readily recognize from the following discussion that alternative embodiments of the systems and methods illustrated herein can be modified in various ways without departing from the principles of the invention, as described herein.

### DETAILED DESCRIPTION OF THE DRAWINGS

A given individual often interacts with various IoT systems, IoT devices, and/or IoT sensors (which are directly or indirectly related to one or more domains) on a regular basis (e.g., daily). These various IoT systems, IoT devices, and/or IoT sensors collect IoT data associated with the given individual in relation to the one or more domains passively and/or based on user interaction. However, IoT data associated with the given individual is often discretely analyzed for a corresponding: predetermined purpose, predetermined IoT system, predetermined IoT device, predetermined IoT sensor(s), and/or predetermined domain. Thus, latent user behaviors (e.g., risky actions, risk propensities, risk patterns/trends, etc.) that can be gleaned from IoT data associated with the given individual often remain unidentified. These latent user behaviors can include valuable behavioral insights associated with the given individual that can have unintuitive implications, such as cross-domain and/or multi-domain relevance. For example, IoT data collected from a smart stove of the given individual that exhibits that the smart stove is frequently left on high heat overnight might prove to have a latent correlation (e.g., statistical, trajectory, inferential) with subsequent careless operation of an automobile of the given individual the following morning, such as performance of unsafe lane mergers detected by an ADAS system of the automobile. Conversely, IoT data collected from the ADAS system that demonstrates the performance of the unsafe lane mergers might bear a latent correlation to the given individual subsequently leaving their smart stove on high heat overnight.

Various embodiments include a computer-implemented method. The method can include receiving a first set of sensor data associated with a user from one or more first IoT devices of the user related to a first domain. The method also can include receiving a second set of sensor data associated with the user from one or more second IoT devices of the user related to a second domain. The method additionally can include analyzing the first set of sensor data associated with the user from the one or more first IoT devices of the user related to the first domain and the second set of sensor data associated with the user from the one or more second IoT devices of the user related to the second domain to identify one or more risks of the user. The method further can include generating one or more risk scores associated with the user based on the one or more risks of the user. The method additionally can include recalculating an insurance premium for one or more of a multi-domain insurance policy of the user, a first-domain insurance policy of the user, a second-domain insurance policy of the user, or a third-domain insurance policy of the user based on the one or more risk scores associated with the user.

A number of embodiments include a system comprising one or more processors and one or more non-transitory computer-readable media storing computing instructions that, when run on the one or more processors, cause the one or more processors to perform various operations. The operations can include receiving a first set of sensor data associated with a user from one or more first IoT devices of the user related to a first domain. The operations also can include receiving a second set of sensor data associated with the user from one or more second IoT devices of the user related to a second domain. The operations additionally can include analyzing the first set of sensor data associated with the user from the one or more first IoT devices of the user related to the first domain and the second set of sensor data associated with the user from the one or more second IoT devices of the user related to the second domain to identify one or more risks of the user. The operations further can include generating one or more risk scores associated with the user based on the one or more risks of the user. The operations additionally can include recalculating an insurance premium for one or more of a multi-domain insurance policy of the user, a first-domain insurance policy of the user, a second-domain insurance policy of the user, or a third-domain insurance policy of the user based on the one or more risk scores associated with the user.

Some embodiments include one or more non-transitory computer-readable media storing computing instructions that, when run on one or more processors, cause the one or more processors to perform various operations. The operations can include receiving a first set of sensor data associated with a user from one or more first IoT devices of the user related to a first domain. The operations also can include receiving a second set of sensor data associated with the user from one or more second IoT devices of the user related to a second domain. The operations additionally can include analyzing the first set of sensor data associated with the user from the one or more first IoT devices of the user related to the first domain and the second set of sensor data associated with the user from the one or more second IoT devices of the user related to the second domain to identify one or more risks of the user. The operations further can include generating one or more risk scores associated with the user based on the one or more risks of the user. The operations additionally can include recalculating an insurance premium for one or more of a multi-domain insurance policy of the user, a first-domain insurance policy of the user, a second-domain insurance policy of the user, or a third-domain insurance policy of the user based on the one or more risk scores associated with the user.

Advantages will become more apparent to those skilled in the art from the following description of the preferred embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In many embodiments, the systems and methods described herein can provide various practical applications and technological improvements. Some of these various practical applications and technological improvements can be related to, for example: user risk analysis, user risk scoring, and/or user risk analysis modelling based at least partially on latent risks/inferenced gleaned from analysis of IoT data obtained from different IoT systems, IoT devices, IoT sensors, locations, and/or time periods; user behavioral modelling (e.g., predictive behavioral modelling), user behavioral simulation, and/or determining/generating/transmitting user behavioral warnings/notifications based on the analyzed latent risks and/or associated contexts; actuarial data science; IoT ecosystems and/or integration/cooperativity of IoT systems, IoT devices, and/or IoT sensors; determining/modifying/transmitting (e.g., automatically) modifications to/generation of digital insurance policies and/or insurance policy premiums/deductibles and/or stored computer-readable instructions therefor; consumer safety; and/or determining/generating/implementing functional safety modifications (e.g., tailored to a particular user) and/or computer-readable program instructions to modify parameters of operation for one or more IoT ecosystems, IoT systems, IoT devices, and/or IoT sensors, etc.

### Exemplary Computer Systems

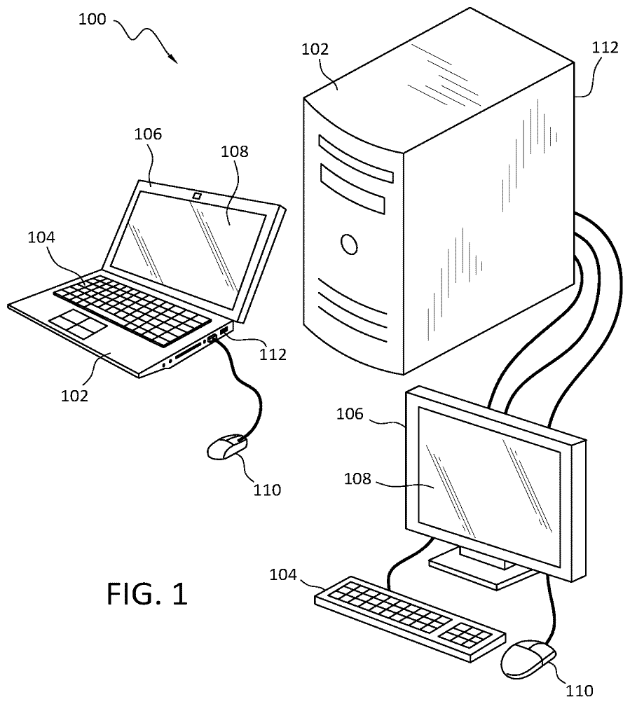

Turning to the drawings, FIG. 1 illustrates an exemplary embodiment of two different types (e.g., a laptop and a tower server) a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

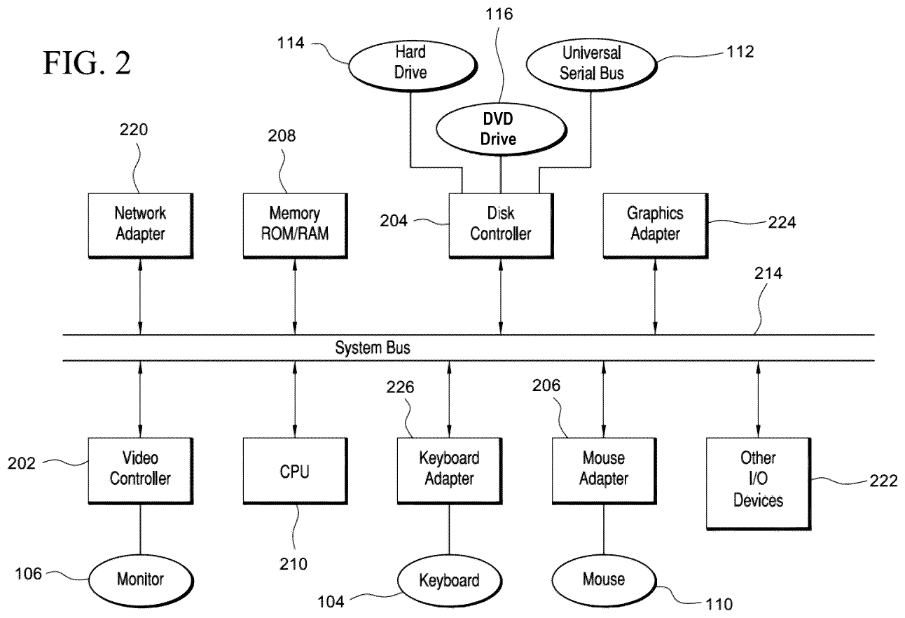

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in CD-ROM and/or DVD drive 116 (FIG. 2) inside chassis 102 (FIG. 1) or in a detachable drive coupled to input/output port 112 (FIGS. 1-2).

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS.

Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable drive coupled to input/output port 112 (FIGS. 1-2), on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100 and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, wearable, virtual reality headset, augmented reality glasses, etc. In certain additional embodiments, computer system 100 can comprise an embedded system.

### Exemplary Computer Systems for Determining Risk Scores for a User Based on Behavioral Inferences from User IoT Data

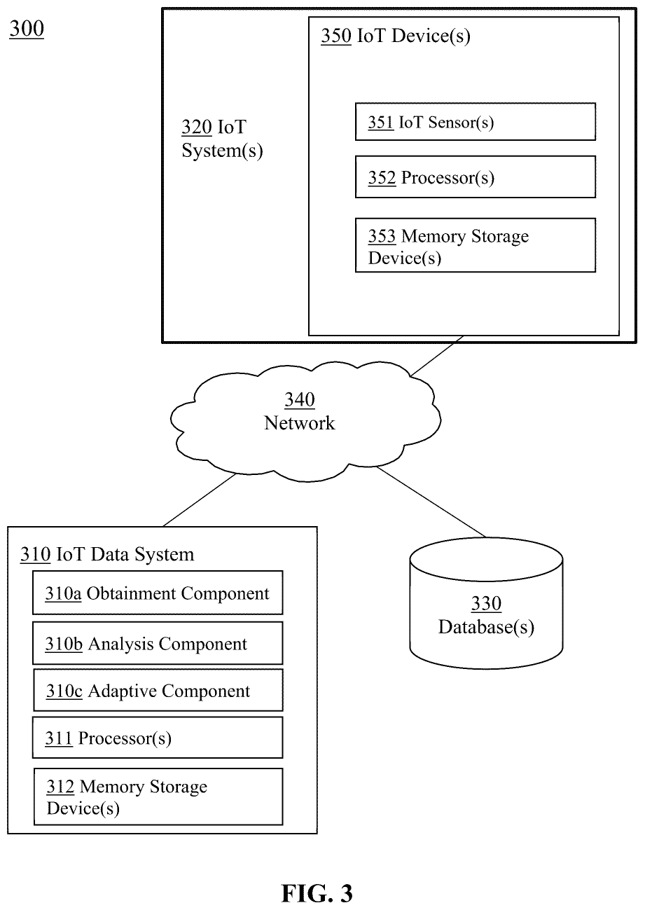

Turning ahead in the drawings, FIG. 3 illustrates a block diagram of a system 300 for determining risk scores for a user based on behavioral inferences from user IoT data, according to some embodiments. The system 300 is exemplary, and comprehensive embodiments of the system 300 are not limited to the specific example embodiments presented herein. The system 300 can be employed in many different embodiments and/or with various modifications which are not necessarily exhaustively illustrated and/or described herein. In some embodiments, certain elements, modules, or systems of the system 300 can perform various procedures, processes, operations, actions, and/or activities. In some embodiments, the procedures, processes, operations, actions, and/or activities can be performed by other suitable elements, modules, components, and/or systems of the system 300.

Generally, therefore, the system 300 can be implemented with hardware and/or software, as described herein. In some embodiments, part or all the hardware and/or software can be customized (e.g., optimized and/or otherwise modified) for implementing part or all the functionality of the system 300 described herein.

In some embodiments, the system 300 can include and/or otherwise be connected to various elements, which themselves can be at least partially interconnected with one another, such as a determining user risk from an IoT data system 310, one or more IoT ecosystems, one or more IoT systems 320, one or more databases 330, one or more networks 340 (e.g., the Internet), one or more IoT devices 350, and/or one or more IoT sensors 351. The network 340 can be connected to/interconnect one or more of the determining user risk from IoT data system 310, the one or more IoT ecosystems, the one or more IoT systems 320, the one or more databases 330, the one or more IoT devices 350, and/or the one or more IoT sensors 351. The determining user risk from IoT data system 310 can perform various processes, including: obtaining IoT data from various sources; user risk analysis, user risk scoring, and/or user risk analysis modelling based at least partially on latent risks/inferenced gleaned from performing machine learning processes (e.g., supervised learning, unsupervised learning, reinforcement learning, neural networks (e.g., deep learning), time-series analysis, natural language processing, and/or feature engineering/extraction, etc.) to analyze obtained IoT data (e.g., textual multimedia, audio multimedia, visual multimedia, metadata, sensor data, geotags, and/or user inputs, etc.) from the one or more IoT ecosystems, the one or more IoT systems 320, the one or more IoT devices 350, the one or more IoT sensors 351, one or more locations, and/or one or more time periods; user behavioral modelling (e.g., predictive behavioral modelling), user behavioral simulation, and/or determining/generating/transmitting user behavioral warnings/notifications based on the analyzed latent risks, risk scores, and/or associated contexts; actuarial data science; generating/modifying IoT ecosystems and/or integration/cooperativity of the one or more IoT systems 320, the one or more IoT devices 250, and/or the one or more IoT sensors 351; determining/modifying/transmitting (e.g., automatically) modifications to/generation of digital insurance policies (e.g., terms, stipulations, phrasings, conditions, coverages, and data/display therefor, etc.) and/or insurance policy premiums/deductibles and/or stored computer-readable instructions therefor; consumer safety; and/or determining/generating/implementing functional safety modifications (e.g., tailored to a particular user of the one or more users) and/or computer-readable program instructions to modify parameters of operation for one or more IoT systems (e.g., connectivity, permissions, shared data, related functions/domains, such as based on latent determined relationships in one or more IoT domains, etc.), IoT devices, and/or IoT sensors, etc.

The determining user risk from IoT data system 310 can include an obtainment component 310a, an analysis component 310b, an adaptive component 310c, one or more processors 311, and/or one or more memory storage devices 312. The one or more IoT systems 320 can include and/or otherwise be connected to one or more of: the one or more IoT ecosystems, the one or more IoT devices 350, and/or the one or more IoT sensors 351. The one or more IoT devices 350 can include and/or otherwise be connected to one or more of: the one or more IoT ecosystems, the one or more IoT systems 320, the one or more IoT sensors 351, one or more processors 352, and/or one or more memory storage devices 353. One or more of: the one or more IoT systems 320, the one or more IoT devices 350, and/or the one or more IoT sensors 351 can be associated with one or more of the one or more users. One or more mobile devices of the respective one or more users can: represent an IoT device included in the one or more IoT ecosystems and/or the one or more IoT systems 320; represent an IoT device of the one or more IoT devices 350; include one or more IoT sensors of the one or more IoT sensors 351; include software and/or a graphical user interface (GUI) for the one or more users to view/interact with the determining user risk from IoT data system 310; include a local application for at least some of the processes of the determining user risk from IoT data system 310, and/or transmit data between (i.e., to/from) the determining user risk from IoT data system 310 and one or more of the other elements of the various elements included in the system 300.

One or more of the one or more IoT systems 320, the one or more IoT devices 350, and/or the one or more IoT sensors 351 can include respective elements that are related to and/or are at least partially used in relation to one or more of the one or more domains (e.g., vehicles, dwellings, and/or healthcare, custom predetermined domain, etc.), such as a first domain, a second domain, a third domain, multi-domain (e.g., consumer IoT comprised of dwellings and/or healthcare, etc.). The one or more domains can include one or more custom predetermined/generated composite (e.g., overlapping) domains, such as comprised of the one or more domains which relate to categories/purposes corresponding to latent analyzed relationships in user risks/scores/contexts associated with the one or more domains or unique categories of interest which might not necessarily be associated with a pre-existent, specific domain of IoT data (e.g., types of one or more insurance policies (e.g., life insurance)), but the present invention is not limited thereto. The one or more composite domains can be predetermined and/or generated by the obtainment component 310a to combine/sort/filter different domains of IoT data at or subsequent to obtainment of the IoT data, accordingly. The obtainment component 310a can generate computer-readable instructions/implement one or more connectivity/permissions/tasks/shared data of the one or more IoT ecosystems, the one or more IoT systems 320, and/or elements thereof. In an embodiment, the first domain can be related to vehicles, the second domain can be related to dwellings, the third domain can be related to healthcare, and the fourth domain can be a composite category related to life insurance and/or life expectancy. The one or more IoT systems 320 can include, for example, one or more vehicle IoT systems, one or more dwelling IoT systems, and/or one or more healthcare IoT systems, however, embodiments are not limited thereto.

The one or more databases 330 can include one or more IoT databases for the one or more domains, one or more data repositories associated with the one or more domains, and/or one or more insurer databases. The one or more databases 330 can store, for example, computer-readable instructions described herein, the IoT data, such as one or more of vehicle IoT data; dwelling IoT data; healthcare IoT data; composite domain IoT data; insurer data (e.g., claim history/amount/liability, insurance policies, insurance premiums, claim causation/occurrence, etc.); one or more context features (e.g., time of day, time periods, location, ambient noise/conversation, hazards within a predetermined vicinity, indicia of user multi-tasking, etc.)); one or more instruction tutorials/manuals and/or analyzed features thereof for proper usage of the one or more IoT devices 350 and/or the one or more IoT systems 320, one or more analyzed risks for the one or more users; one or more generated risk scores for the one or more users; one or more risk analysis models (e.g., comprehensive and/or for one or more of the one or more domains); one or more risk analysis model features; one or more risk analysis thresholds for IoT data; one or more risk analysis model training datasets; one or more risk analysis model weights and/or biases; one or more risk score generation models (e.g., comprehensive and/or for one or more of the one or more domains); one or more risk score generation model features and/or vectors; one or more risk score thresholds/criterion/thresholds; one or more risk score generation model training datasets; one or more risk score generation model weights and/or biases; one or more credentials for the one or more users; one or more IP addresses for the one or more users; one or more recognized IoT devices of the one or more IoT devices 350 of the one or more users; legal names of the one or more users; one or more behavioral inferences for one or more domains associated with the one or more users; one or more insurance policy premiums (e.g., for the one or more domains, a multi-domain, umbrella policy, and/or life insurance, etc.) associated with the one or more users; and/or can include a vehicle IoT database, a dwelling IoT database, and/or a healthcare IoT database.

The one or more vehicle IoT systems can include one or more vehicle IoT devices and/or one or more vehicle IoT sensors, which can capture vehicle IoT data, but they do not necessarily need to be specifically or exclusively dedicated to the vehicle domain. The one or more vehicle IoT systems, the one or more vehicle IoT devices, and the one or more vehicle IoT sensors can collectively be referred to as vehicle IoT components. For example, vehicle IoT components can include any of the following, among others:
1. Advanced Driver Assistance Systems (ADAS)
   Devices:
      Lane Departure Warning System
      Adaptive Cruise Control System
      Automatic Emergency Braking System
      Blind Spot Monitoring System
      Traffic Sign Recognition System
   Sensors:
      Cameras
      Radar Sensors
      LiDAR Sensors
2. Telematics Systems
   Devices:
      Telematics Control Unit (TCU)
      OBD-II Adapter
      Fleet Management Systems
      Mobile Device
   Sensors:
      GPS Sensors
      Accelerometers
      Gyroscopes
      Engine Temperature Sensors
      Oil Pressure Sensors
      Fuel Level Sensors
3. Collision Avoidance Systems
   Devices:
      Collision Detection System
      Impact Detection System
      Emergency Braking Assist
   Sensors:
      Ultrasonic Sensors
      Distance Sensors
      G-Force Sensors
4. Tire Monitoring Systems
   Devices:
      Direct TPMS (Tire Pressure Monitoring System)
      Indirect TPMS
   Sensors:
      Tire Pressure Sensors
      Wheel Speed Sensors
      Temperature Sensors
5. Battery Management Systems
   Devices:
      Battery Management Unit
      Smart Charging Station
   Sensors:
      Voltage Sensors
      Temperature Sensors
      Current Sensors
6. Environmental Control Systems
   Devices:
      Climate Control Unit
      Air Purification System
   Sensors:
      Temperature Sensors
      Humidity Sensors
      Air Quality Sensors
      Pollution Sensors
7. Emergency Response Systems
   Devices:
      Automatic Crash Notification Device
      Emergency Alert System
   Sensors:
      Location Sensors
      Impact Sensors
      G-Force Sensors
8. Smart Mirrors
   Devices:
      Smart Rearview Mirror
      Smart Sideview Mirrors
      Integrated Display Mirror
   Sensors:
      Camera Sensors
      Light Sensors
9. Smart Parking Systems
   Devices:
      Smart Parking Meter
      Parking Guidance System
   Sensors:
      Ultrasonic Sensors
      Ground Sensors
      Image Sensors
10. Remote Start Systems
   Devices:
      Remote Start Device
      Keyless Entry System
      Smart Key System
   Sensors:
      Proximity Sensors
      Temperature Sensors
11. Vehicle Health Monitoring Systems
   Devices:
      Diagnostic Tool
      Maintenance Alert System
   Sensors:
      Engine Temperature Sensors
      Oil Pressure Sensors
      Battery Voltage Sensors
      Fluid Level Sensors
12. Connected Car Systems
   Devices:
      Vehicle-to-Everything (V2X) Communication Device
      In-Vehicle Infotainment System
      Radar Detectors
   Sensors:
      GPS Sensors
      Dash Cams
      Communication Modules
13. Autonomous Driving Systems
   Devices:
      Self-Driving Hardware
      Control Units
   Sensors:
      LiDAR Sensors
      Radar Sensors
      Camera Sensors

The one or more dwelling IoT systems can include one or more dwelling IoT devices and/or one or more dwelling IoT sensors, which can capture dwelling IoT data, but they do not necessarily need to be specifically or exclusively dedicated to the dwelling domain. The one or more dwelling IoT systems, the one or more dwelling IoT devices, and the one or more dwelling IoT sensors can collectively be referred to as dwelling IoT components. For example, dwelling IoT components can include any of the following, among others:
1. Smart Home Security Systems
   Devices:
      Security Cameras
      Smart Locks
      Alarm Systems
      Smart Doorbells
   Sensors:
      Motion Sensors
      Door/Window Sensors
      Camera Sensors
      Glass Break Sensors
2. Home Automation Hubs
   Devices:
      Home Automation Hub
      Smart Speaker
   Sensors:
      Temperature Sensors
      Humidity Sensors
      Motion Sensors
3. Smart Climate Control Systems
   Devices:
      Smart Thermostat
      Smart HVAC Controller
   Sensors:
      Temperature Sensors
      Humidity Sensors
      Air Quality Sensors
4. Smart Lighting Systems
   Devices:
      Smart Light Bulbs
      Smart Light Switches
   Sensors:
      Motion Sensors
      Light Sensors
5. Smart Home Energy Management Systems
   Devices:
      Smart Plugs
      Energy Monitors
   Sensors:
      Power Consumption Sensors
      Temperature Sensors
6. Smart Irrigation Systems
   Devices:
      Smart Sprinkler Controller
   Sensors:
      Soil Moisture Sensors
      Weather Sensors
7. Smart Appliances
   Devices:
      Smart Refrigerator
      Smart Oven
      Smart Washer and Dryer
      Smart Dishwasher
      Smart Coffee Maker
   Sensors:
      Temperature Sensors
      Humidity Sensors
      Water Leak Sensors
8. Smart Smoke, Fire, and CO/CO₂ Detectors
   Devices:
      Smart Smoke Detector
      Smart Carbon Monoxide/Carbon Dioxide Detectors
   Sensors:
      Smoke Sensors
      CO/CO₂ Sensors
      Flame detectors
9. Smart Water Leak Detectors
   Devices:
      Water Leak Sensor
   Sensors:
      Water Leak Sensors
10. Smart Home Assistants
   Devices:
      Smart Speaker
      Smart Display
   Sensors:
      Microphones
      Cameras
11. Smart Garage Door Openers
   Devices:
      Smart Garage Door Opener
   Sensors:
      Door Position Sensors
      Motion Sensors
12. Smart Curtains and Blinds
   Devices:
      Smart Blinds
   Sensors:
      Light Sensors
      Temperature Sensors
13. Environmental Monitoring Systems
   Devices:
      Smart Air Quality Monitor
   Sensors:
      Air Quality Sensors
      Temperature Sensors
      Humidity Sensors

The one or more healthcare IoT systems can include one or more healthcare IoT devices and/or one or more healthcare IoT sensors, which can capture healthcare IoT data, but they do not necessarily need to be specifically or exclusively dedicated to the healthcare domain. The one or more healthcare IoT systems, the one or more healthcare IoT devices, and the one or more healthcare IoT sensors can collectively be referred to as healthcare IoT components. For example, healthcare IoT components can include any of the following, among others:
1. Remote Patient Monitoring Systems
   Devices:
      Wearable Health Monitors
      Telehealth Platforms
   Sensors:
      Heart Rate Monitors
      Blood Pressure Sensors
      Glucose Monitors
      Oxygen Saturation Sensors
2. Telemedicine Systems
   Devices:
      Telemedicine Platforms
      Video Conferencing Equipment
   Sensors:
      Digital Stethoscopes
      Pulse Oximeters
3. Smart Health Records Systems
   Devices:
      Electronic Health Record (EHR) Systems
      Patient Management Software
   Sensors:
      Data Entry Devices (e.g., Barcode Scanners)
4. Chronic Disease Management Systems
   Devices:
      Diabetes Management Devices
      Asthma Management Devices
   Sensors:
      Blood Glucose Sensors
      Spirometers
5. Medication Management Systems
   Devices:
      Smart Pill Bottles/Dispensers
      Connected Inhalers
      Medication Tracking Apps
   Sensors:
      Pill Count Sensors
      Reminder Notification Systems
6. Smart Rehabilitation Systems
   Devices:
      Physical Therapy Equipment with IoT Capability
      Virtual Rehabilitation Platforms
   Sensors:
      Motion Sensors
      Feedback Sensors
7. Smart Hospital Systems
   Devices:
      Bedside Monitors
      Smart Infusion Pumps
   Sensors:
      Patient Monitoring Sensors (e.g., ECG, EEG)
      Environmental Sensors (e.g., temperature, humidity)
8. Wearable Health Devices
   Devices:
      Fitness Trackers
      Smart Glasses
      Smart Sleep Trackers
      Continuous Positive Airway Pressure (CPAP) Devices
   Sensors:
      Accelerometers
      Heart Rate Sensors
      Sleep Quality Sensors
      GPS Sensors
9. Environmental Monitoring Systems
   Devices:
      Smart Air Quality Monitors
   Sensors:
      Air Quality Sensors
      Temperature Sensors
      Humidity Sensors
10.Emergency Response Systems
   Devices:
      Personal Emergency Response Systems (PERS)
      Emergency Alert Devices
   Sensors:
      Fall Detection Sensors
      GPS Location Sensors

The obtainment component 310a can obtain (e.g., receive and/or collect) the IoT data associated with the one or more users, such as via the network 340, from the one or more IoT ecosystems, the one or more IoT systems 320, the one or more databases 330, the one or more IoT devices 350, and/or the one or more IoT sensors 351. The IoT data can be collected by the obtainment component 310a dynamically, passively, incidentally, continuously, at predetermined intervals, randomly, and/or upon detection of a triggering condition (e.g., manual user input, initiation and/or modification to an insurance policy of the one or more users, use/disengagement of one or more of the one or more IoT devices 350 by the one or more users, one or more threshold values of IoT data from the one or more IoT sensors 351, one or more detected context features (e.g., travelling to/leaving work, environmental conditions, location, and/or time, etc.), predetermined risk features, predetermined user behaviors, predetermined user mind-states, predetermined spoken/typed keywords, etc.). The IoT data associated with the one or more users can be stored in the one or more databases 330. The IoT data can be cataloged and stored in the database 330 according to various relevant/predetermined/learned criteria, such as predetermined identifiers of the one or more other users (e.g., login credentials, given legal names, recognized IoT devices of the one or more IoT devices 350 (e.g., user devices), voice of the one or more users, recognizable writing syntax, contexts, etc.), automatic identification of the one or more users from analyzed features/patterns of the IoT data and/or by one or more relevant inputs of the one or more users.

The determining risk scores for a user based on behavioral inferences from IoT data system 310 can analyze the IoT data associated with the one or more users via an analysis component 310b. The analysis component 310b can analyze the obtained IoT data (e.g., identify risks/actions, determine behavioral inferences, generate risk scores, extract features, learn weights/biases/vectors, learn trends/patterns, learn contexts, and/or map a combination of the same, etc.) associated with the one or more users using one or more relevant machine learning processes (e.g., as aforementioned, natural language processing (NLP), computer vision, text-to-speech, pattern recognition, etc.) and/or one or more relevant neural networks (e.g., trained and/or modified based on one or more tasks/processes/steps associated with determining risk scores for a user based on behavioral inferences from user IoT data), such as based on the one or more domains, multi-domain, composite domain, and/or comprehensively (i.e., overall). For example, machine learning and/or neural networks can include any of the following, among others:
1. Supervised Learning
   Classification Algorithms: These can be used to categorize users based on their behaviorial patterns, enabling the identification of high-risk individuals. Example algorithms can include:
      Logistic Regression: A statistical model that can predict the probability of a binary outcome (e.g., risky/negligent v. safe behavior(s)).
      Decision Trees: A flowchart-like structure that can make decisions according to feature values, identifying critical decision points that precede/relate to risky behavior.
      Random Forests: An ensemble of one or more decision trees that can enhance categorical classification accuracy, such as via combining the results of multiple trees, consequently reducing overfitting.
      Support Vector Machines (SVM): Can be effective for high-dimensional spaces, the algorithm can find an “optimal” hyperplane that can separate various classes.
      Neural Networks:
         Feedforward Neural Networks: Simple neural networks can learn complex patterns, such as with respect to user behavior through multiple layers.
         Deep Learning: Can utilize multiple layers of neurons to learn intricate relationships in input data, which can be especially beneficial when dealing with large datasets.
2. Unsupervised Learning
   Clustering: This technique can group the one or more users according to similarities in behavioral patterns, such as risky behaviors, helping to identify segments of the one or more users with relatively high-risk characteristics.
      K-Means Clustering: Segments of the one or more users can be clustered based on similarities in features, enabling targeted interventions/insights.
      Hierarchical Clustering: Can build a tree of clusters, facilitating visualization of the behavioral actions/relationships of the one or more users.
   Anomaly Detection: Can identify outliers, such as in user behavioral actions/contexts that can be indicative of negligence and/or risk.
      Isolation Forest: A method that can be specifically designed for anomaly detection, which can be effective, for example, in identifying unusual behavioral patterns of the one or more users.
      Autoencoders: Neural networks that can learn to compress and reconstruct input data, which can be useful, for example, for detecting deviations from typical behavioral actions/contexts of the one or more users.
3. Reinforcement Learning
   Behavior Modeling: This approach can enable models to adapt based on feedback from interactions of the one or more users, which can help reinforce positive behaviors and/or discourage negative ones. Reinforcement learning can facilitate adjustment to strategies in real-time, such as to enhance user safety and/or mitigate risk.
4. Time-series Analysis
   Recurrent Neural Networks (RNNs): Particularly Long Short-Term Memory (LSTM) networks, these can be highly useful for analyzing sequences of user actions over a predetermined time period and can capture spatial-temporal dependencies and patterns/trends in user behavioral actions, assisting in prediction of future risky actions and/or patterns.
5. Natural Language Processing (NLP)
   Sentiment Analysis: Can analyze feedback of the one or more users, comments, or social media interactions to gauge user sentiment towards risk-related issues or express conveyance of the same, which can help to understand attitudes and/or potential risky/negligent behavioral actions.
6. Feature Engineering
   Can develop new features that effectively represent user behavioral patterns/actions/contexts, which can significantly enhance model performance. This can involve creating metrics from raw IoT data and/or combining existing features to better capture risk propensity.

The analysis component 310b can determine one or more risks associated with the one or more users via the analysis of the collected IoT data in relation to the one or more IoT data domains (e.g., the first domain, the second domain, the third domain, multi-domain, composite domain, and/or comprehensively, etc.). The one or more risks can be based on one or more deviations/anomalies in the obtained IoT data relative to one or more predetermined/historic/comparative thresholds and/or predictions for: one or more behaviors (e.g., behavioral actions, trends, patterns, parameters of the one or more IoT device 350 usage/disengagement, etc.) of the one or more users; one or more detected mind-states (e.g., distracted, confused, agitated, sad, frustrated, etc.) of the one or more users and predispositions/contexts precipitating them; one or more contexts associated with the one or more behaviors of the one or more users (e.g., times, durations, sequences, frequencies, locations, ambient temperatures, ambient air quality, hazards within a predetermined distance, multitasking, distractions, analyzed prior risks within a predetermined time period, etc.); and/or one or more health indicators (e.g., change in vital signs, poor quality sleep, audible breathlessness, abnormal gait, falls, irregular speech, etc.) of the one or more users. The analysis component 310b can score the severity and/or likelihood associated with the one or more risks; determine one or more compounded/composite/cross-affective risks; determine one or more cross-domain/multi-domain/composite domain contextual/spatiotemporal risks; one or more realizations of risk, the outcome, and/or the severity, predisposition to stress/distraction/risk; transient and/or permanent health factors, etc. The one or more risks associated with the user and/or the one or more other users can be identified for the one or more domains, cross-domain, composite domain, multi-domain, and/or the one or more IoT devices 350. The analysis component 310b can generate one or more risk scores associated with the user based on the analyzed one or more risks of the user. The one or more risk scores associated with the user and/or the one or more other users can be identified for the one or more domains, cross-domain, multi-domain, composite domain, cross-affective domains, etc., and/or the one or more IoT devices 350. The one or more risk scores associated with the user can include one or more of a generalized risk score for the user, a cross-domain risk score for the user, a composite domain risk score for the user, a multi-domain risk score for the user, a first-domain risk score for the user, a second domain risk score for the user, and/or a third-domain risk score for the user, etc. The analysis component 310b can determine one or more latent correlations, such as in one or more of user risk, context, outcome, and/or risk scores. For example, the analysis component 310b can determine one or more latent correlations between the one or more identified first-domain based risks of the user and the one or more identified second-domain based risks of the user that manifest given certain biometric data of the user within a predetermined period of time. The user and the one or more other users can be compared (e.g., clustered, distinguished, ranked, etc.) based on one or more of a predetermined location/area, respective risks, contexts, and/or one or more respective risk scores by the one or more domains, cross-domain, composite domain, multi-domain, the one or more IoT systems 320, and/or the one or more IoT devices 350, etc.

The adaptive component 310c can recalculate one or more insurance policy premiums for one or more domains based on the analyzed collected IoT data for one or more users. The adaptive component 310c can further modify terms and/or corresponding text of the one or more insurance policies of the one or more users to code associated with a digital representation of the one or more insurance policies and/or generate computer programming instructions for the same. The adaptive component 310c can also determine one or more functional safety modifications to operation of one or more of the one or more IoT devices 350 of the one or more users based on one or more of the one or more analyzed risks (and bases therefor), one or more of the one or more generated risk scores, comparisons between the IoT data of the user and one or more other users, the generated risk scores for one or more of the one or more users, and/or respective contexts for use of the one or more IoT devices 350 by the one or more users (e.g., according to predetermined IoT devices, predetermined actions, predetermined domains of the one or more domains, and/or predetermined risk types of the one or more risk types, etc.). The one or more functional safety modifications can include establishing/restricting parameters for operation of predetermined IoT devices, such as upon a triggering condition. The triggering condition can be based upon a predetermined constellation of IoT data features (e.g., mapped features); predetermined analyzed risks and/or predetermined generated risk scores; predetermined times/time periods; predetermined locations/areas; predetermined contexts; predetermined users; and/or one or more predetermined IoT devices of the one or more IoT devices 350, etc. The one or more functional safety modifications can include implementing predetermined minimum and/or maximum use durations/intensities/times/time periods; capacity to perform predetermined actions and/or start/stop the same; minimum and/or maximum idle times; adjusted input sensitivities, etc. to mitigate analyzed/predicted risks and/or the generated risk scores associated with the one or more domains, cross-domain, composite domain, multi-domain, and/or context, etc.

The adaptive component 310c can generate/transmit computing instructions for implementing the one or more functional safety modifications (e.g., via the network 340) to the one or more predetermined IoT devices of the one or more IoT devices 350 to directly effectuate the one or more functional safety modifications, such as in an autonomous manner. The adaptive component 310c can transmit a notification to the predetermined user with explanations regarding the one or more functional safety modifications, the analyzed risks, the generated risk scores, comparisons to one or more other uses, and/or can allow the predetermined user to override/modify one or more of the one or more functional safety modifications. If the user opts into permitting/accepts the one or more functional safety modifications, and/or does not otherwise override them one or more of a predetermined number of times/durations, the user can automatically receive an incentive (e.g., predetermined reimbursement, predetermined reduction in one or more insurance policy premiums, predetermined discounts, etc.) and/or their risk scores can be adjusted accordingly. The received incentive can be equal to or less than a calculated potential cost savings to the insurer, such as based on application of an actuarial model. The actuarial model can be dynamically trained based on the risk analysis model, the risk score generation model, one or more predetermined users and/or one or more predetermined IoT devices.

### Exemplary Methods for Determining Risk Scores for a User Based on Behavioral Inferences from User IoT Data

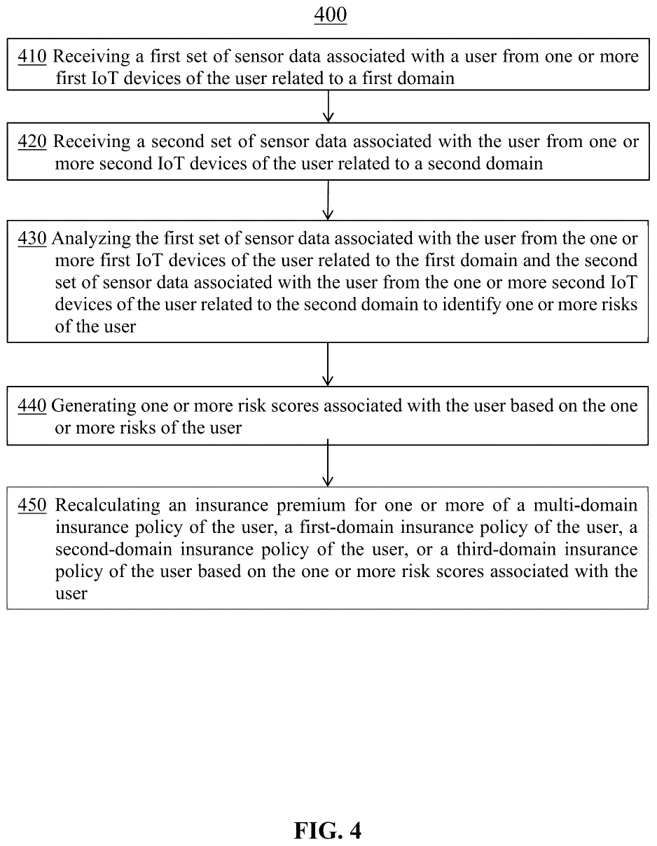

Turning ahead in the drawings, FIG. 4 illustrates actions of a method 400 for determining whether a user is driving under the influence of certain substances, according to certain embodiments. Method 400 can be implemented via execution of computing instructions configured to run on one or more processors and stored on one or more non-transitory computer-readable media. Method 400 is exemplary and is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined or skipped.

In many embodiments, system 300 or IoT data system 310 (FIG. 3) (including one or more of its elements, modules, and/or systems, etc.) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media. Such non-transitory computer readable media can be part of a computer system such as system 300 or IoT data system 310. The processor(s) can be similar or identical to the processor(s) described above with respect to computer system 100 (FIG. 1).

Referring to FIG. 4, in many embodiments, method 400 can include an activity 410 of receiving a first set of sensor data associated with a user from one or more first IoT devices of the user related to a first domain. The first IoT devices can be similar or identical to one or more of IoT devices 350 (FIG. 3) related to the first domain. Method 400 also can include an activity 420 of receiving a second set of sensor data associated with the user from one or more second IoT devices of the user related to a second domain. The second IoT devices can be similar or identical to one or more of IoT devices 350 (FIG. 3) related to the second domain. Method 400 also can include an activity 430 of analyzing the first set of sensor data associated with the user from the one or more first IoT devices of the user related to the first domain and the second set of sensor data associated with the user from the one or more second IoT devices of the user related to the second domain to identify one or more risks of the user. Method 400 also can include an activity 440 of generating one or more risk scores associated with the user based on the one or more risks of the user. Method 400 also can include an activity 450 of recalculating an insurance premium for one or more of a multi-domain insurance policy of the user, a first-domain insurance policy of the user, a second-domain insurance policy of the user, or a third-domain insurance policy of the user based on the one or more risk scores associated with the user.

### Exemplary Machine Learning Models

In many embodiments, the systems and/or methods can use one or more ML/AI models to perform one or more of the above-mentioned procedures, processes, activities, actions, operations, and/or methods. Further, the systems and/or methods can use one or more natural language processing (NLP) models for processing the one or more inputs and/or outputs (e.g., interpreting user feedback). Examples of the algorithms used for the various ML/AI models can include BERT, LLM, Lambda, Palm, XLNet, GPT-3, GPT-4, KNN, decision trees, linear regression, K-Means, neural networks, fuzzy logic, GANs, CTGAN, CNNs, VAEs, and so forth. In various embodiments, each of the ML/AI models used can be trained dynamically and/or regularly.

In many embodiments, the systems and/or methods can be configured to train or re-train the one or more ML/AI models. The training of each of the ML/AI models can be supervised, semi-supervised, and/or unsupervised, which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., database(s) 330 (FIG. 3)).

In some embodiments, the systems, methods, and/or system users (e.g., a data scientist) further can determine whether to add the newly-created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

### Additional Considerations

Although determining risk scores for a user based on behavioral inferences from user IoT data has been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIG. 1-4 can be modified, and that the foregoing discussion of certain of these embodiments does not necessarily represent a complete description of all possible embodiments. Additionally, one or more of the procedures, processes, operations, actions, and/or activities of the method in FIG. 4 can include different procedures, processes, actions, and/or activities and be performed by many different modules, in many different orders. As another example, the modules, models, elements, and/or systems within system 300 or IoT data system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a”or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method, comprising:
receiving a first set of sensor data associated with a user from one or more first IoT devices of the user related to a first domain;
receiving a second set of sensor data associated with the user from one or more second IoT devices of the user related to a second domain;
analyzing the first set of sensor data associated with the user from the one or more first IoT devices of the user related to the first domain and the second set of sensor data associated with the user from the one or more second IoT devices of the user related to the second domain to identify one or more risks of the user;
generating one or more risk scores associated with the user based on the one or more risks of the user; and
recalculating an insurance premium for one or more of a multi-domain insurance policy of the user, a first-domain insurance policy of the user, a second-domain insurance policy of the user, or a third-domain insurance policy of the user based on the one or more risk scores associated with the user.

2. The computer-implemented method of claim 1, wherein:
the first domain is vehicles;
the second domain is dwellings or user health;
the one or more first IoT devices include one or more vehicle IoT devices; and
the one or more second IoT devices include one or more of (i) one or more consumer IoT devices or (ii) one or more healthcare IoT devices.

3. The computer-implemented method of claim 2, wherein the one or more vehicle IoT devices include one or more of one or more connected cars, one or more telematics devices, one or more vehicle-to-everything (V2X) systems, one or more dash cams, one or more smart key systems, or one or more advanced driver assistances systems (ADAS).

4. The computer-implemented method of claim 3, wherein:
the one or more consumer IoT devices include one or more of one or more smart thermostats, one or more smart speakers, one or more smart lights, one or more security cameras, one or more security systems, or one or more smart appliances; and
the one or more healthcare IoT devices include one or more of one or more wearable health trackers, one or more remote patient monitoring devices, one or more smart pill bottles, one or more connected inhalers, or one or more telehealth platforms.

5. The computer-implemented method of claim 4, wherein:
the one or more risks associated with the user include one or more identified first-domain based risks of the user and one or more identified second-domain based risks of the user; and
the one or more risk scores associated with the user include one or more of a generalized risk score for the user, a multi-domain risk score for the user, a first-domain risk score for the user, a second domain risk score for the user, or a third-domain risk score for the user.

6. The computer-implemented method of claim 5, further comprising:
determining one or more latent correlations between the one or more identified first-domain based risks of the user and the one or more identified second-domain based risks of the user.

7. The computer-implemented method of claim 1, wherein analyzing the first set of sensor data associated with the user from the one or more first IoT devices of the user related to the first domain and the second set of sensor data associated with the user from the one or more second IoT devices of the user related to the second domain to identify the one or more risks of the user is performed, at least partially, via one or more neural networks or one or more machine learning processes to extract one or more predetermined features associated with the one or more risks of the user.

8. The computer-implemented method of claim 1, further comprising:
determining one or more functional safety modifications to one or more of the one or more first IoT devices or the one or more second IoT devices based on the one or more risks of the user and respective contexts;
generating computer-readable instructions to implement the one or more functional safety modifications via one or more processors of the one or more of the one or more first IoT devices or the one or more second IoT devices;
transmitting the computer-readable instructions to implement the one or more functional safety modifications to the one or more processors of the one or more of the one or more first IoT devices or the one or more second IoT devices; and
performing the computer-readable instructions to implement the one or more functional safety modifications via the one or more processors of the one or more of the one or more first IoT devices or the one or more second IoT devices.

9. A system comprising:
one or more processors; and
one or more non-transitory computer-readable media storing computing instructions that, when run on the one or more processors, cause the one or more processors to perform operations comprising:
receiving a first set of sensor data associated with a user from one or more first IoT devices of the user related to a first domain;
receiving a second set of sensor data associated with the user from one or more second IoT devices of the user related to a second domain;
analyzing the first set of sensor data associated with the user from the one or more first IoT devices of the user related to the first domain and the second set of sensor data associated with the user from the one or more second IoT devices of the user related to the second domain to identify one or more risks of the user;
generating one or more risk scores associated with the user based on the one or more risks of the user; and
recalculating an insurance premium for one or more of a multi-domain insurance policy of the user, a first-domain insurance policy of the user, a second-domain insurance policy of the user, or a third-domain insurance policy of the user based on the one or more risk scores associated with the user.

10. The system of claim 9, wherein:
the first domain is vehicles;
the second domain is dwellings or user health;
the one or more first IoT devices include one or more vehicle IoT devices; and
the one or more second IoT devices include one or more of (i) one or more consumer IoT devices or (ii) one or more healthcare IoT devices.

11. The system of claim 10, wherein the one or more vehicle IoT devices include one or more of one or more connected cars, one or more telematics devices, one or more vehicle-to-everything (V2X) systems, one or more dash cams, one or more smart key systems, or one or more advanced driver assistances systems (ADAS).

12. The system of claim 11, wherein:
the one or more consumer IoT devices include one or more of one or more smart thermostats, one or more smart speakers, one or more smart lights, one or more security cameras, one or more security systems, or one or more smart appliances; and
the one or more healthcare IoT devices include one or more of one or more wearable health trackers, one or more remote patient monitoring devices, one or more smart pill bottles, one or more connected inhalers, or one or more telehealth platforms.

13. The system of claim 12, wherein:
the one or more risks associated with the user include one or more identified first-domain based risks of the user and one or more identified second-domain based risks of the user; and
the one or more risk scores associated with the user include one or more of a generalized risk score for the user, a multi-domain risk score for the user, a first-domain risk score for the user, a second domain risk score for the user, or a third-domain risk score for the user.

14. The system of claim 13, wherein the operations further comprise:
determining one or more latent correlations between the one or more identified first-domain based risks of the user and the one or more identified second-domain based risks of the user.

15. The system of claim 9, wherein analyzing the first set of sensor data associated with the user from the one or more first IoT devices of the user related to the first domain and the second set of sensor data associated with the user from the one or more second IoT devices of the user related to the second domain to identify the one or more risks of the user is performed, at least partially, via one or more neural networks or one or more machine learning processes to extract one or more predetermined features associated with the one or more risks of the user.

16. The system of claim 9, wherein the operations further comprise:
determining one or more functional safety modifications to one or more of the one or more first IoT devices or the one or more second IoT devices based on the one or more risks of the user and respective contexts;
generating computer-readable instructions to implement the one or more functional safety modifications via one or more processors of the one or more of the one or more first IoT devices or the one or more second IoT devices;
transmitting the computer-readable instructions to implement the one or more functional safety modifications to the one or more processors of the one or more of the one or more first IoT devices or the one or more second IoT devices; and
performing the computer-readable instructions to implement the one or more functional safety modifications via the one or more processors of the one or more of the one or more first IoT devices or the one or more second IoT devices.

17. One or more non-transitory computer-readable media storing computing instructions that, when run on one or more processors, cause the one or more processors to perform operations comprising:
receiving a first set of sensor data associated with a user from one or more first IoT devices of the user related to a first domain;
receiving a second set of sensor data associated with the user from one or more second IoT devices of the user related to a second domain;
analyzing the first set of sensor data associated with the user from the one or more first IoT devices of the user related to the first domain and the second set of sensor data associated with the user from the one or more second IoT devices of the user related to the second domain to identify one or more risks of the user;
generating one or more risk scores associated with the user based on the one or more risks of the user; and
recalculating an insurance premium for one or more of a multi-domain insurance policy of the user, a first-domain insurance policy of the user, a second-domain insurance policy of the user, or a third-domain insurance policy of the user based on the one or more risk scores associated with the user.

18. The one or more non-transitory computer-readable media of claim 17, wherein:
the first domain is vehicles;
the second domain is dwellings or user health;
the one or more first IoT devices include one or more vehicle IoT devices; and
the one or more second IoT devices include one or more of (i) one or more consumer IoT devices or (ii) one or more healthcare IoT devices.

19. The one or more non-transitory computer-readable media of claim 18, wherein the one or more vehicle IoT devices include one or more of one or more connected cars, one or more telematics devices, one or more vehicle-to-everything (V2X) systems, one or more dash cams, one or more smart key systems, or one or more advanced driver assistances systems (ADAS).

20. The one or more non-transitory computer-readable media storing computing instructions of claim 19, wherein:
the one or more consumer IoT devices include one or more of one or more smart thermostats, one or more smart speakers, one or more smart lights, one or more security cameras, one or more security systems, or one or more smart appliances; and
the one or more healthcare IoT devices include one or more of one or more wearable health trackers, one or more remote patient monitoring devices, one or more smart pill bottles, one or more connected inhalers, or one or more telehealth platforms.
